(19) United States
(12) Patent Application Publication
(10) Pub. No.: US 2024/0176330 A1
(43) Pub. Date: May 30, 2024

(54) MANUFACTURING SITE INTEGRATED MANAGEMENT SYSTEM AND METHOD FOR ROOT INDUSTRY

(71) Applicant: XN SOLUTIONS CO., LTD., Seoul (KR)

(72) Inventors: Myoung Su LEE, Incheon (KR); Yeon Jo JEONG, Anyang-si (KR); Se Gok OH, Seoul (KR)

(21) Appl. No.: 18/511,969

(22) Filed: Nov. 16, 2023

(30) Foreign Application Priority Data
Nov. 30, 2022 (KR) 10-2022-0164754

(51) Int. Cl. G05B 19/4155

(52) U.S. Cl. CPC G05B 19/4155; G05B 2219/31372

(57) ABSTRACT

Provided are a manufacturing site integrated management system and method for root industry. The method is a manufacturing site integrated management method for root industry that is performed by a server, and includes generating standard data by repeatedly learning big data based on root industry, receiving manufacturing site data for a manufacturing site, analyzing the received manufacturing site data, and generating manufacturing analysis data, and generating manufacturing management data using the manufacturing analysis data on the basis of the standard data, wherein the generating of the manufacturing management data includes extracting energy usage and carbon emissions using the manufacturing analysis data to measure an actual production volume of a product and an actual lifetime of an apparatus and generate management measurement data, and analyzing the management measurement data to estimate an estimated production volume of the product and an estimated lifetime of the apparatus for remaining lifetime excluding the actual lifetime on the basis of a total lifetime of the apparatus and generate management estimation data using data that matches the standard data.

### CROSS-REFERENCE TO RELATED APPLICATION

This application claims priority to and the benefit of Korean Patent Application No. 2002-0164754, filed on Nov. 30, 2022, the disclosure of which is incorporated herein by reference in its entirety.

### BACKGROUND

### 1. Field of the Invention

The present invention relates to a manufacturing site monitoring system and method for root industry, and more particularly, to a manufacturing site integrated management system and method for root industry that can efficiently manage a site by monitoring the site of the root industry in real time.

### 2. Discussion of Related Art

Generally, the root industry is the process technology industry utilized throughout the manufacturing industry, such as casting, molding, plastic processing, welding, surface treatment, heat treatment, and the like.

Most root industry companies are not large in scale, and systems such as a manufacturing execution system (MES) and the like, which are mainly used by large companies, are not properly established.

Accordingly, there are many companies that have limitations in establishing automation of the manufacturing process itself or efficiently performing process operations.

Systematic systems that can establish process automation suited to the characteristics of the manufacturing process of such root industry and increase the operational efficiency of the manufacturing process are required.

The points described as the related art above are only for the purpose of improving understanding of the related art of the present invention, and should not be taken as an acknowledgment that they correspond to the related art already known to those skilled in the art.

### RELATED ART DOCUMENT

### Patent Document

(Patent Document 0001) Korean Patent Registration No. 10-2302395

### SUMMARY OF THE INVENTION

The present invention is directed to providing a manufacturing site integrated management system and method for root industry.

Objects of the present invention are not limited to the above-described object and other objects that are not described may be clearly understood by those skilled in the art from the following descriptions.

According to an aspect of the present invention, there is provided a manufacturing site integrated management method for root industry, which is performed by a server, including generating standard data by repeatedly learning big data based on root industry, receiving manufacturing site data for a manufacturing site, analyzing the received manufacturing site data, and generating manufacturing analysis data, and generating manufacturing management data using the manufacturing analysis data on the basis of the standard data, wherein the generating of the manufacturing management data includes extracting energy usage and carbon emissions using the manufacturing analysis data to measure an actual production volume of a product and an actual lifetime of an apparatus and generate management measurement data, and analyzing the management measurement data to estimate an estimated production volume of the product and an estimated lifetime of the apparatus for remaining lifetime excluding the actual lifetime on the basis of a total lifetime of the apparatus and generate management estimation data using data that matches the standard data.

The generating of the manufacturing analysis data may include classifying the manufacturing site data by each field corresponding to at least one of casting, molding, welding, plastic processing, surface treatment, and heat treatment, classifying the manufacturing site data by each apparatus for manufacturing products manufactured by each field, classifying the manufacturing site data by each process corresponding to at least one of working time, non-working time, after-sales service (AS) time, and working speed for each piece of an apparatus, or classifying the manufacturing site data by each product corresponding to at least one of a casting product, a molding product, a welding product, a plastic processing product, a surface treatment product, and a heat treatment product, and analyzing the manufacturing site data classified by each field, apparatus, process, or product on the basis of the standard data and generating the manufacturing analysis data.

The manufacturing site integrated management method may include, before the generating of the manufacturing analysis data, converting the manufacturing site data into text, preprocessing the manufacturing site data converted into the text, and extracting a keyword from the preprocessed text, wherein the preprocessing of the manufacturing site data includes performing a tokenization operation using a space removal filter and a special character removal filter so that words included in the manufacturing site data consisting of text are divided into minimum units of meaningful words, after the tokenization operation has been completed, performing a refining operation to highlight the meaning of remaining words after removing noise data for words that appear less frequently or words that are repeated many times in the text, and after the refining operation has been completed, normalizing the text and preprocessing the manufacturing site data.

The classifying of the manufacturing site data may further include classifying the manufacturing site data by each biosignal corresponding to at least one of fatigue, movement, and working hours of a worker, and whether the worker commutes to work or classifying the manufacturing site data by each site environment corresponding to at least one of temperature, humidity, smoke, flames, harmful gas, fine dust concentration, oxygen concentration, noise, and vibrations, wherein the generating of the manufacturing management data further includes generating management control data for controlling the manufacturing site to calculate a maximum production volume of the product and a maximum lifetime of the apparatus in response to the management estimation data.

The generating of the manufacturing management data may include generating a simulation model using the management estimation data, generating simulated manufacturing site data simulated by each field, apparatus, process, or product at the manufacturing site through the simulation model, analyzing the simulated manufacturing site data and generating simulated manufacturing analysis data, extracting the energy usage and the carbon emissions using the simulated manufacturing analysis data to simulate a maximum production volume of the product and a maximum lifetime of the apparatus and generate simulation result data, and generating the manufacturing management data including the management estimation data reflecting the simulation result data.

According to another aspect of the present invention, there is provided a manufacturing site integrated management system for root industry, including a site control device that is placed at a manufacturing site and configured to generate manufacturing site data for the manufacturing site, and a management server configured to generate manufacturing analysis data by comparing and analyzing the manufacturing site data, and generate manufacturing management data using the manufacturing analysis data on the basis of standard data, wherein the management server extracts energy usage and carbon emissions using the manufacturing analysis data and measures a production volume of a product and a lifetime of an apparatus to generate management measurement data, and analyzes the management measurement data and estimates an estimated production volume of the product and an estimated lifetime of the apparatus for remaining lifetime excluding the actual lifetime on the basis of a total lifetime of the apparatus to generate management estimation data using data that matches the standard data.

According to still another aspect of the present invention, there is provided a program combined with a computer that is hardware, wherein the program is stored in a computer-readable recording medium so as to perform the manufacturing site integrated management method for root industry.

Other specific details of the present invention are included in the detailed descriptions and accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a conceptual diagram for describing a manufacturing site integrated management system for root industry according to an embodiment of the present invention;

FIG. 2 is a diagram for describing a detailed configuration of the manufacturing site integrated management system for root industry illustrated in FIG. 1;

FIG. 3 is a diagram for describing a manufacturing site integrated management method for root industry according to an embodiment of the present invention;

FIG. 4 is a flowchart for describing an operation of generating manufacturing analysis data illustrated in FIG. 3;

FIG. 5 is a flowchart for describing an operation of generating manufacturing management data illustrated in FIG. 3;

FIG. 6 is a flowchart for describing an operation of generating management estimation data according to another embodiment of the present invention; and

FIG. 7 is a flowchart for describing an operation of generating training result data according to still another embodiment of the present invention.

### DETAILED DESCRIPTION OF EXEMPLARY EMBODIMENTS

Advantages and features of the present invention and methods of achieving the same will be clearly understood with reference to the accompanying drawings and embodiments described in detail below. However, the present invention is not limited to the embodiments to be disclosed below but may be implemented in various different forms. The embodiments are provided in order to fully explain the present embodiments and fully explain the scope of the present invention to those skilled in the art. The scope of the present invention is only defined by the appended claims.

Terms used herein are provided only to describe the embodiments of the present invention and not for purposes of limitation. In this specification, the singular forms include the plural forms unless the context clearly indicates otherwise. It will be understood that the terms “comprise” and/or “comprising” used herein specify the stated components but do not preclude the presence or addition of one or more other components. Like reference numerals refer to like elements throughout the specification, and the term “and/or” includes any and all combinations of one or more of referents. It should be understood that, although the terms “first,” “second,” etc. may be used herein to describe various components, these components are not limited by these terms. These terms are only used to distinguish one component from another component. Therefore, it should be understood that a first component to be described below may be a second component within the technical spirit of the present invention.

Unless otherwise defined, all terms (including technical and scientific terms) used herein may be used as is customary in the art to which the present invention belongs. Further, it will be further understood that terms, such as those defined in commonly used dictionaries, will not be interpreted in an idealized or overly formal sense unless expressly so defined herein.

Hereinafter, embodiments of the present invention will be described in detail with reference to the accompanying drawings.

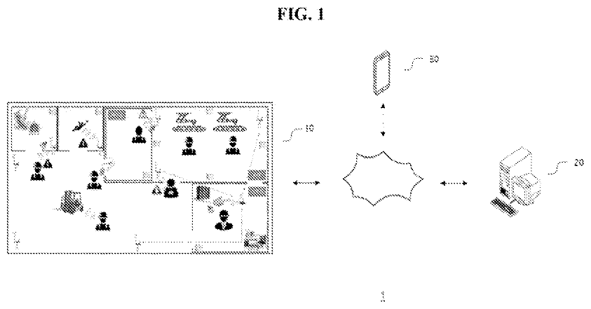

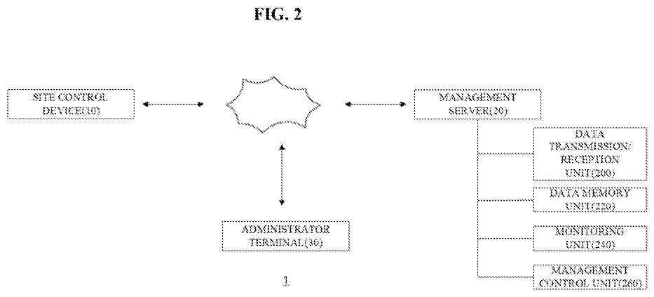

FIG. 1 is a conceptual diagram for describing a manufacturing site integrated management system for root industry according to an embodiment of the present invention, and FIG. 2 is a diagram for describing a detailed configuration of the manufacturing site integrated management system for root industry illustrated in FIG. 1.

In the present embodiment, a manufacturing site integrated management system 1 for root industry is a system that manages a manufacturing site in an integrated manner by providing non-face-to-face root industry of the manufacturing site, which is required for manufacturing industry, such as casting, mold, welding, plastic processing, surface treatment, and heat treatment, but the present invention is not limited thereto.

As illustrated in FIGS. 1 and 2, the manufacturing site integrated management system 1 for root industry according to the embodiment of the present invention may include a site control device 10, a management server 20, and an administrator terminal 30. In this case, the administrator terminal 30 may be omitted.

Here, the site control device 10, the management server 20, and the administrator terminal 30 may be synchronized in real time to transmit or receive data using a wireless communication network. The wireless communication network may support various long-distance communication methods, for example, various communication methods such as a wireless local area network (WLAN), digital living network alliance (DLNA), wireless broadband (WiBro), world interoperability for microwave access (WiMAX), global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), Institute of Electrical and Electronics Engineers (IEEE) 802.16, long term evolution (LTE), long term evolution-advanced (LTEA), wireless mobile broadband service (WMBS), Bluetooth low energy (BLE), Zigbee, radio frequency (RF), long range (LoRa), and the like may be used, but the present invention is not limited thereto, and various widely known wireless or mobile communication methods may be used.

In the present invention, the site control device 10 may operate using an application program (or application), and the application program may be downloaded from an external server or the management server 20 through wireless communication.

Specifically, the site control device 10 is a device placed at a manufacturing site, and may transmit manufacturing site data for the manufacturing site in real time through the management server 20 and receive manufacturing management data corresponding to the manufacturing site data in real time.

In this case, the manufacturing management data may include management measurement data, management estimation data, and management control data, but the present invention is not limited thereto.

The management measurement data may be data obtained by actually measuring an actual production volume of a product and an actual lifetime of an apparatus, the management estimation data may be data obtained by estimating an estimated production volume of the product and an estimated lifetime of the apparatus, and the management control data may be data for controlling the manufacturing site so as to calculate a maximum production volume of the product and a maximum lifetime of the apparatus, but the present invention is not limited thereto. Here, the actual production volume of the product may be data representing the actual production volume of the product, the actual lifetime of the apparatus may be data representing the usage of the apparatus actually used to produce the product, the estimated production volume of the product may be data obtained by estimating the production volume of the product that can be produced using the apparatus on the basis of the actual production volume of the product, and the estimated lifetime of the apparatus may be data obtained by estimating a remaining lifetime excluding the actual lifetime of the apparatus on the basis of a total lifetime of the apparatus, but the present invention is not limited thereto.

In some embodiments, the management estimation data may be data reflecting simulation result data, additional management data, or training result data.

For example, the site control device 10 may generate the manufacturing site data for the manufacturing site in real time through a separate measurement device placed at the manufacturing site, and receive manufacturing management data corresponding to the manufacturing site data in real time.

The site control device 10 may collect field-specific information corresponding to at least one of casting, molding, welding, plastic processing, surface treatment, and heat treatment from the manufacturing site.

Further, the site control device 10 may collect field-specific information on each apparatus for manufacturing products in real time from the manufacturing site.

Further, the site control device 10 may collect process-specific information corresponding to at least one of working time, non-working time, after-sales service (AS) time, and working speed for each apparatus in real time from the manufacturing site.

Further, the site control device 10 may collect product-specific information corresponding to at least one of a casting product, a molding product, a welding product, a plastic processing product, a surface treatment product, and a heat treatment product in real time from the manufacturing site.

Further, the site control device 10 may collect site environment-specific information in real time from the manufacturing site. In this case, the site environment-specific information may include information on at least one of temperature, humidity, smoke, flames, harmful gas, fine dust concentration, oxygen concentration, noise, and vibrations, but the present invention is not limited thereto.

In some embodiments, the site control device 10 may receive weather information at the manufacturing site in conjunction with information from the Korea Meteorological Administration, which is public data, or may measure weather information through a separate measuring apparatus. In this case, the weather information may include information on at least one of temperature, humidity, snowfall, rainfall, wind direction, wind speed, harmful gas, fine dust concentration, oxygen concentration, noise, and vibrations outside the manufacturing site.

Further, the site control device 10 may collect biosignal-specific information on a subject whose movement is detected, in real time from the manufacturing site. In this case, the biosignal-specific information may include information corresponding to at least one of fatigue, movement, and working hours of a worker, and whether the worker commutes to work, but the present invention is not limited thereto.

In some embodiments, the site control device 10 may generate biosignals by measuring a heart rate, a body temperature, a blood pressure, and a blood oxygen level of each individual subject through a separate terminal.

In this case, the site control device 10 may receive, in advance, physical information on a subject, such as height, weight, musculoskeletal mass, body fat mass, etc. and medical information, such as medical records, medication information, biometric parameter information, drug reactivity, family history, expert opinions, etc.

Accordingly, the site control device 10 may generate manufacturing site data using the site-specific information, the process-specific information, the product-specific information, the site environment-specific information and the biosignal-specific information that are collected in real time.

In some embodiments, the site control device 10 may transmit the collected information or the generated manufacturing site data to the management server 20.

Further, the site control device 10 may generate manufacturing site data in real time, and when the site control device 10 receives manufacturing management data corresponding to the generated manufacturing site data, the site control device 10 may manage the manufacturing site on the basis of the manufacturing management data.

For example, when the site control device 10 receives manufacturing management data corresponding to manufacturing site data, the site control device 10 may execute the manufacturing management data visually and audibly.

Further, the site control device 10 may use a simulation model that is generated based on the manufacturing management data generated in response to manufacturing site data to generate simulated manufacturing site data.

Specifically, the site control device 10 may use the simulation model to generate simulated manufacturing site data simulated by each field, apparatus, process, or product at the manufacturing site.

Further, after on-site integrated management is completed, the site control device 10 may generate feedback information about the completion of the on-site integrated management and transmit the generated feedback information.

The feedback information may include information such as satisfaction, accuracy, and reliability for the on-site integrated management. In this case, the feedback information may be generated and transmitted after the on-site integrated management is used, but alternatively, the feedback information may be transmitted before or while the on-site integrated management is used.

In some embodiments, the site control device 10 may receive advertising information, or event information including information about discounts or events for the on-site integrated management from the management server 20, but the present invention is not limited thereto.

Further, the site control device 10 may visually and audibly provide manufacturing site management training to a worker or an administrator before or after receiving manufacturing management data.

Specifically, the site control device 10 may provide root industry of the manufacturing site non-face-to-face, and provide manufacturing site management training before or after receiving manufacturing management data in order to comprehensively manage the manufacturing site.

For example, the site control device 10 may receive training result data generated by evaluating a result and score of manufacturing site management training according to the execution of the manufacturing site management training for on-site integrated management.

Specifically, the worker or administrator may need retraining when the result of the manufacturing site management training is lower than a standard, according to the training result data. That is, the worker or administrator may perform on-site integrated management more efficiently through retraining.

In some embodiments, the site control device 10 may generate training result data by comparing and analyzing pre-mission performance data for the manufacturing site management training performed before on-site integrated management with post-mission performance data for the manufacturing site management training performed after on-site integrated management.

In some embodiments, when the site control device 10 receives standard data from the management server 20, the site control device 10 may generate manufacturing management data corresponding to manufacturing site data.

In some embodiments, when the site control device 10 receives a request for additional data related to the manufacturing site data before receiving the manufacturing management data after the management server 20 transmits initial manufacturing site data, the site control device 10 may transmit the additional data for the manufacturing site data to the management server 20 and receive manufacturing management data reflecting the additional data from the management server 20.

In some embodiments, the site control device 10 may receive the manufacturing management data reflecting only the additional data or receive manufacturing management data not reflecting additional data.

The management server 20 may include a data transmission/reception unit 200, a data memory unit 220, a monitoring unit 240, and a management control unit 260.

The data transmission/reception unit 200 may transmit/receive data to/from the site control device 10.

The data transmission/reception unit 200 may transmit/receive data to/from the administrator terminal 30.

The data memory unit 220 may be configured to store the data transmitted/received to/from the site control device 10 or the administrator terminal 30 through a wireless communication network.

The data memory unit 220 may be configured to store data supporting various functions of the management server 20. The data memory unit 220 may be configured to store a plurality of application programs (or application) running on the management server 20, data for operation of the management server 20, and commands. At least some application programs may be downloaded from an external server through wireless communication.

The monitoring unit 240 may monitor an operating state of the site control device 10, an operating state of the management server 20, data transmitted/received to/from the site control device 10 or the administrator terminal 30, and the like, in real time through a screen. That is, by checking a usage state of the site control device 10 in real time, it is possible to make it convenient for a user to use and provide greater confidence to the user and administrator.

When the management control unit 260 receives manufacturing site data from the site control device 10, the management control unit 260 may generate manufacturing management data on the basis of standard data.

Specifically, when the management control unit 260 receives manufacturing site data for the manufacturing site through the site control device 10 placed at the manufacturing site, the management control unit 260 may analyze the manufacturing site data to generate manufacturing analysis data, and use manufacturing analysis data generated based on standard data to generate manufacturing management data.

First, the management control unit 260 may determine whether the received manufacturing site data is text, voice, image, or conversation data, and preprocess the manufacturing site data so that the manufacturing site data is clearly recognized.

When the manufacturing site data is text, the management control unit 260 may preprocess the manufacturing site data by sequentially performing a tokenization operation, a refining operation, and a normalization operation. That is, the management control unit 260 may perform a tokenization operation to filter the manufacturing site data consisting of text, perform a refining operation to remove noise data included in the data for which the tokenization operation has been completed, and then normalize and preprocess the data for which the refining operation has been completed.

For example, the management control unit 260 may perform a tokenization operation using a space removal filter and a special character removal filter so that words included in text are divided into minimum units of meaningful words, perform a refining operation to highlight the meaning of remaining words after removing noise data for words that appear less frequently or words that are repeated many times in the data after the tokenization operation has been completed, and then normalize and preprocess the data after the refining operation has been completed.

In this case, the management control unit 260 may quantify the noise data, and determine whether to remove the noise data in response to the manufacturing site data.

In some embodiments, the management control unit 260 may automatically check and convert typos included in the text or automatically remove duplicate data.

On the other hand, when the manufacturing site data is a video, the management control unit 260 may extract images for each frame of the video for 10 seconds or more, and convert the images extracted for each frame into text. The converted text may be preprocessed.

In this case, the management control unit 260 may automatically adjust the brightness and sharpness of the video in consideration of a surrounding environment, shaking, a moving speed, etc. corresponding to the manufacturing site data consisting of the video.

Further, when the manufacturing site data is an image, the management control unit 260 may convert the image into text. The converted text may be preprocessed.

On the other hand, when the manufacturing site data is voice or conversation data, the management control unit 260 may preprocess the voice or conversation data and convert the preprocessed voice or conversation data into text. The data converted from the voice or conversation data to the text may be preprocessed.

The management control unit 260 may extract keywords from the manufacturing site data that is preprocessed in this way and consists of text.

The management control unit 260 may classify and analyze the manufacturing site data by each field, apparatus, process, or product using the keywords extracted from the manufacturing site data on the basis of the standard data to generate manufacturing analysis data.

Specifically, the management control unit 260 may classify the manufacturing site data by each field corresponding to at least one of casting, molding, welding, plastic processing, surface treatment, and heat treatment using the keywords included in the manufacturing site data, classify the manufacturing site data by each apparatus for manufacturing products manufactured by each field, classify the manufacturing site data by each process corresponding to at least one of working time, non-working time, AS time, and working speed for each apparatus, or classify the manufacturing site data by each product corresponding to at least one of a casting product, a molding product, a welding product, a plastic processing product, a surface treatment product, and a heat treatment product.

In some embodiments, the management control unit 260 may classify the manufacturing site data by each biosignal or site environment using the keywords included in the manufacturing site data to generate manufacturing management data corresponding thereto.

For example, the management control unit 260 may classify the manufacturing site data by each biosignal corresponding to at least one of fatigue, movement, and working hours of a worker, and whether the worker commutes to work using the keywords included in the manufacturing site data, or classify the manufacturing site data by each site environment corresponding to at least one of temperature, humidity, smoke, flames, harmful gas, fine dust concentration, oxygen concentration, noise, and vibrations.

Further, the management control unit 260 may generate manufacturing management data using manufacturing analysis data on the basis of standard data.

Specifically, the management control unit 260 may extract energy usage and carbon emissions using manufacturing analysis data to generate management measurement data, and analyze the management measurement data to generate management estimation data using data that matches the standard data.

For example, the management control unit 260 may extract energy usage and carbon emissions using manufacturing analysis data and measure the actual production volume of the product and the actual lifetime of the apparatus to generate management measurement data, and analyze the management measurement data and estimate the estimated production volume of the product and the estimated lifetime of the apparatus to generate management estimation data using data that matches standard data. That is, the management control unit 260 may analyze the management measurement data and estimate the estimated production volume of the product and the estimated lifetime of the apparatus for the remaining lifetime excluding the actual lifetime on the basis of the total lifetime of the apparatus to generate management estimation data using the data that matches the standard data.

Further, the management control unit 260 may generate manufacturing management data using management estimation data on the basis of standard data.

Specifically, the management control unit 260 may generate a simulation model using management estimation data, analyze the simulated manufacturing site data simulated by each field, apparatus, process, or product at the manufacturing site using the simulation model to generate simulated manufacturing analysis data, and extract energy usage and carbon emissions using the simulated manufacturing analysis data and simulate the maximum production volume of the product and the maximum lifetime of the apparatus to generate simulation result data.

That is, the management control unit 260 may generate manufacturing management data that includes management estimation data reflecting simulation result data.

Further, the management control unit 260 may generate management control data for controlling the manufacturing site in response to the management estimation data.

Specifically, the management control unit 260 may use management estimation data to generate management control data for controlling the manufacturing site so as calculate the maximum production volume of the product and the maximum lifetime of the apparatus at the manufacturing site.

Further, when it is difficult for the management control unit 260 to generate manufacturing management data on the basis of manufacturing site data, the management control unit 260 may request additional data from the site control device 10.

Specifically, when the management control unit 260 fails to generate manufacturing management data corresponding to manufacturing site data after receiving initial manufacturing site data from the site control device 10, the management control unit 260 may request additional data from the site control device 10 before transmitting the manufacturing management data, receive the additional data, and then generate manufacturing management data using the manufacturing site data and the additional data on the basis of standard data.

In some embodiments, the management control unit 260 may generate the manufacturing management data reflecting only the additional data without reflecting the initial manufacturing site data, or may generate manufacturing management data not reflecting additional data.

Further, the management control unit 260 may provide non-face-to-face guidance to the site control device 10 placed at the manufacturing site by executing on-site integrated management in response to manufacturing management data.

Specifically, the management control unit 260 may visually and audibly output manufacturing management data in order for the worker or administrator to efficiently manage the manufacturing site in response to the manufacturing site data.

In some embodiments, the management control unit 260 may execute manufacturing site management training before executing on-site integrated management.

For example, the management control unit 260 may perform pre-safety training for integrated management of the manufacturing site. In this case, the manufacturing site management training may include guidelines, safety accidents, precautions, etc., but the present invention is not limited thereto.

In some embodiments, the manufacturing site management training may include details on how to use work tools deployed at the site control device 10.

In some embodiments, the management control unit 260 may execute manufacturing site management training and then evaluate pre-mission performance for the manufacturing site management training.

For example, the management control unit 260 may visually or audibly execute pre-test questions for the manufacturing site management training, receive results corresponding thereto, and generate pre-mission performance data.

When the pre-mission performance data is compared with a preset standard pre-mission performance data value and does not exceed the standard value, the worker or administrator may receive the manufacturing site management training again. That is, when sequential pre-missions for manufacturing site management training cannot be executed, the manufacturing site management training cannot be terminated.

For example, when the pre-mission performance data is not the same as the standard pre-mission performance data, that is, when the pre-mission performance data is not included within a standard range, the management control unit 260 may generate and output a retraining message for re-executing the manufacturing site management training.

In some embodiments, the management control unit 260 may execute manufacturing site management training after on-site integrated management is completed.

For example, the management control unit 260 may perform post-safety training for integrated management of the manufacturing site after on-site integrated management is completed.

In some embodiments, the management control unit 260 may execute manufacturing site management training and then evaluate post-mission performance for the manufacturing site management training.

For example, the management control unit 260 may visually or audibly present post-test problems for the manufacturing site management training, receive results corresponding thereto, and generate post-mission performance data.

When the post-mission performance data is compared with a preset standard post-mission performance data value and does not exceed the standard value, the worker or administrator may receive the manufacturing site management training again. That is, when sequential post-missions for manufacturing site management training cannot be executed, the manufacturing site management training cannot be terminated.

For example, when the post-mission performance data is not the same as the standard post-mission performance data, that is, when the post-mission performance data is not included within a standard range, the management control unit 260 may generate and output a retraining message for re-executing the manufacturing site management training.

Further, the management control unit 260 may compare and analyze the pre-mission performance data for the manufacturing site management training executed before the on-site integrated management with the post-mission performance data for the manufacturing site management training executed after the on-site integrated management to generate the training result data.

In some embodiments, according to the training result data of the worker or administrator, when a result of the manufacturing site management training is lower than a standard value, the management control unit 260 may generate manufacturing management data using the training result data of the worker on the basis of the standard data. That is, the worker or administrator may avoid embarrassment during on-site integrated management through retraining.

In some embodiments, the management control unit 260 may generate manufacturing management data corresponding to unexpected situations related to accidents in integrated management while executing on-site integrated management.

In some embodiments, the management control unit 260 may generate a feedback control signal for improving the on-site integrated management system in response to a feedback signal received from the site control device 10.

In some embodiments, the management control unit 260 may generate a feedback control signal including event information to increase the use of the on-site integrated management system of the site control device 10.

Further, the management control unit 260 may generate standard data by repeatedly learning big data using a deep learning technique or a machine learning technique based on root industry.

In this case, the standard data may be updated in real time in response to the manufacturing management data.

In some embodiments, the management control unit 260 may update the standard data in real time in response to at least one of the feedback signal, the feedback control signal, the training result data, and the manufacturing management data.

The management server 20 may be implemented by hardware circuits (e.g., complementary metal-oxide semiconductor (CMOS)-based logic circuits), firmware, software, or a combination thereof. For example, the management server 20 may be implemented by utilizing transistors, logic gates, and electronic circuits in the form of various electrical structures.

The administrator terminal 30 is a terminal possessed by a separate administrator, and may be synchronized with the site control device 10 and the management server 20 in real time through a wireless communication network to transmit or receive data. In this case, the administrator terminal 30 may transmit or receive data using application programs (or applications).

The administrator terminal 30 may generate manufacturing management data using manufacturing site data on the basis of standard data.

As such, the administrator terminal 30 may include various types of portable electronic communication devices that support communication with the site control device 10 and the management server 20. For example, the site control device 10 is a separate smart device, and may include various portable terminals such as smartphones, personal digital assistants (PDAs), tablet computers, wearable devices, smartwatches, smart glasses, head mounted displays, and various types of Internet of Things (IOT) terminals, but alternatively, the site control device 10 may include electronic communication devices such as desktop computers and workstation computers that are not portable, and the like.

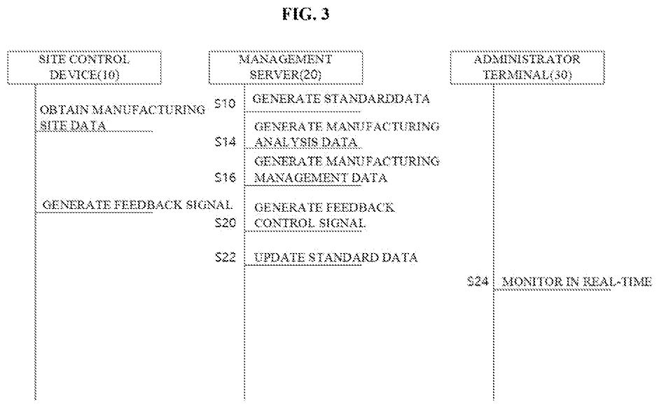

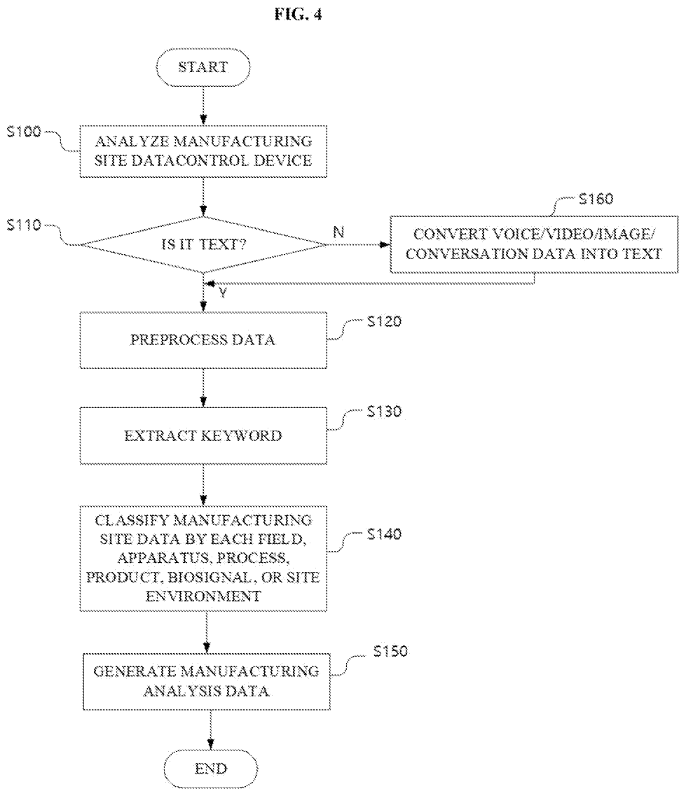

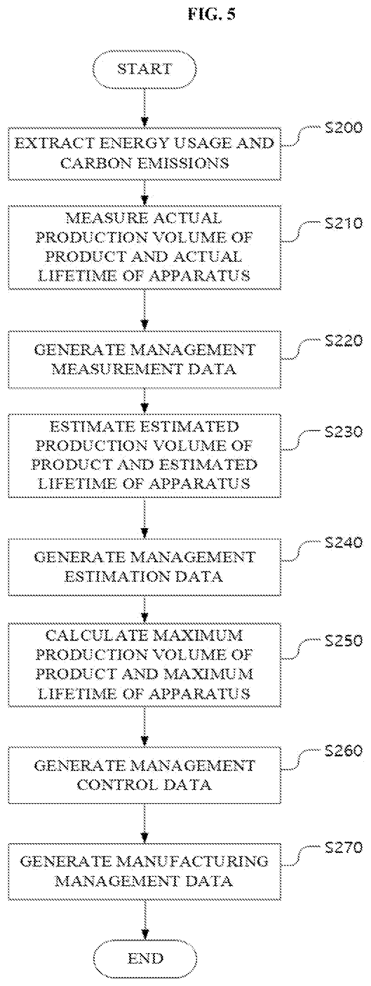

The operation of the manufacturing site integrated management system for root industry according to the embodiment of the present invention having such a structure is as follows. FIG. 3 is a diagram for describing a manufacturing site integrated management method for root industry according to an embodiment of the present invention, FIG. 4 is a flowchart for describing an operation of generating manufacturing analysis data illustrated in FIG. 3, and FIG. 5 is a flowchart for describing an operation of generating manufacturing management data illustrated in FIG. 3.

First, as illustrated in FIG. 3, a management server 20 may generate standard data using big data based on root industry (S10).

For example, the management server 20 may generate standard data for a manufacturing site integrated management system for root industry by repeatedly learning big data using a deep learning technique or a machine learning technique.

Next, the management server 20 may receive manufacturing site data for a manufacturing site from a site control device 10 (S12).

Specifically, the site control device 10 may generate manufacturing site data for the manufacturing site.

For example, the site control device 10 may generate the manufacturing site data using site-specific information, process-specific information, product-specific information, site environment-specific information, and biosignal-specific information that are collected in real time.

Next, when the management server 20 receives the manufacturing site data from the site control device 10, the management server 20 may generate manufacturing analysis data on the basis of the standard data (S14).

Specifically, as illustrated in FIG. 4, when the management server 20 receives the manufacturing site data from the site control device 10, the management server 20 may analyze the received manufacturing site data (S100).

Next, the management server 20 may determine whether the received manufacturing site data is text, and as a result of the determination, when it is determined that the manufacturing site data is text (S110), the management server 20 may perform a pre-processing process on the text so that the manufacturing site data is accurately recognized (S120).

In some embodiments, the manufacturing site data may be preprocessed before determining whether the manufacturing site data is text.

Specifically, the management server 20 may preprocess the text by sequentially performing a tokenization operation, a refining operation, and a normalization operation.

For example, the management server 20 may perform a tokenization operation to filter the manufacturing site data consisting of text, perform a refining operation to remove noise data included in the text data for which the tokenization operation has been completed, and then normalize and preprocess the text for which the refining operation has been completed.

In some embodiments, the management server 20 may automatically check and convert typos included in the text or automatically remove duplicate data.

Next, the management server 20 may extract keywords from the manufacturing site data consisting of the preprocessed text on the basis of the standard data (S130).

Specifically, the management server 20 may extract keywords for each word from the manufacturing site data consisting of the text on the basis of the standard data.

Next, the management server 20 may classify the manufacturing site data using the keywords extracted based on the standard data (S140).

For example, the management server 20 may use the keywords included in the manufacturing site data to classify the manufacturing site data by each field corresponding to at least one of casting, molding, welding, plastic processing, surface treatment, and heat treatment using the keywords included in the manufacturing site data, classify the manufacturing site data by each apparatus for manufacturing products manufactured by each field, classify the manufacturing site data by each process corresponding to at least one of working time, non-working time, AS time, and working speed for each apparatus, classify the manufacturing site data by each product corresponding to at least one of a casting product, a molding product, a welding product, a plastic processing product, a surface treatment product, and a heat treatment product, classify the manufacturing site data by each biosignal corresponding to at least one of fatigue, movement, and working hours of a worker, and whether the worker commutes to work, or classify the manufacturing site data by each site environment corresponding to at least one of temperature, humidity, smoke, flames, harmful gas, fine dust concentration, oxygen concentration, noise, and vibrations.

Next, the management server 20 may analyze the manufacturing site data classified into the site-specific information, the process-specific information, the product-specific information, the site environment-specific information, and the biosignal-specific information using the keywords extracted based on the standard data, and may generate the manufacturing analysis data corresponding thereto (S150).

Meanwhile, when the received manufacturing site data consists of voice, a video, an image, or conversation data rather than text (S110), the management server 20 may convert the manufacturing site data consisting of voice, a video, an image, or conversation data into text so that the manufacturing site data is recognized (S160).

Next, the management server 20 may generate manufacturing management data using the manufacturing analysis data on the basis of the standard data (S16).

Specifically, as illustrated in FIG. 5, the management server 20 may extract energy usage and carbon emissions using the manufacturing analysis data (S200), measure an actual production volume of a product and an actual lifetime of an apparatus (S210), and then generate management measurement data corresponding thereto (S220).

That is, the management server 20 may analyze the management measurement data and estimate an estimated production volume of the product and an estimated lifetime of the apparatus for the remaining lifetime excluding the actual lifetime on the basis of a total lifetime of the apparatus to generate management estimation data using data that matches the standard data.

Next, the management server 20 may analyze the management measurement data to estimate the estimated production volume of the product and the estimated lifetime of the apparatus (S230), and generate management estimation data using data that matches the standard data (S240).

Next, the management server 20 may calculate a maximum production volume of the product and a maximum lifetime of the apparatus at the manufacturing site using the management estimation data on the basis of the standard data (S250), and generate management control data for controlling the manufacturing site in response thereto (S260).

Next, the management server 20 may generate manufacturing management data including the management estimation data and the management control data that correspond to the manufacturing site data on the basis of the standard data (S270).

Next, the site control device 10 may receive a service of on-site integrated management corresponding to the manufacturing site data and then generate a feedback signal for the corresponding service (S18).

In this case, the feedback signal may include information such as satisfaction, accuracy, and reliability for the service.

Next, the management server 20 may generate a feedback control signal for improving the system in response to the feedback signal received from the site control device 10 (S20).

Next, the management server 20 may update the standard data in real time using the manufacturing management data (S22).

In some embodiments, the management server 20 may update the standard data in real time in response to at least one of the feedback signal received from the site control device 10 and the feedback control signal.

Finally, the administrator terminal 30 may monitor the on-site integrated management in real time (S24).

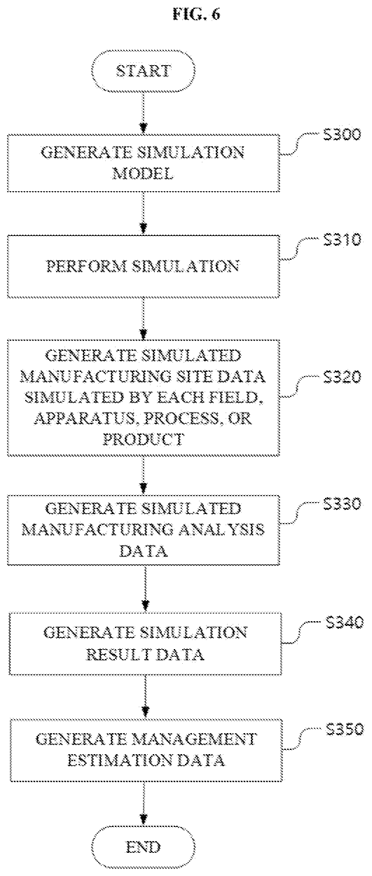

FIG. 6 is a flowchart for describing an operation of generating management estimation data according to another embodiment of the present invention.

As illustrated in FIG. 6, a management server 20 may generate a simulation model using management estimation data (S300), generate simulated manufacturing site data simulated by each field, apparatus, process, or product at a manufacturing site by executing the simulation model at the manufacturing site (S310 and S320), and then analyze the simulated manufacturing site data to generate simulated manufacturing analysis data (S330).

Next, the management server 20 may extract energy usage and carbon emissions using the simulated manufacturing analysis data and simulate a maximum production volume of a product and a maximum lifetime of an apparatus to generate simulation result data (S340), and generate manufacturing management data including management estimation data reflecting the simulation result data (S350).

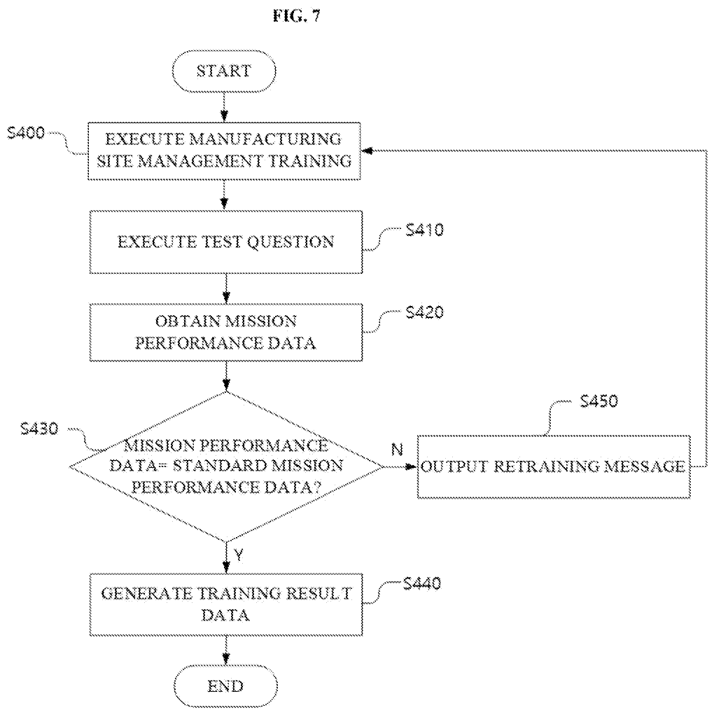

FIG. 7 is a flowchart for describing an operation of generating training result data according to still another embodiment of the present invention.

As illustrated in FIG. 7, a management server 20 may execute manufacturing site management training for integrated management of a manufacturing site (S400).

In some embodiments, pre-safety training and/or post-safety training may be executed for the integrated management of the manufacturing site.

For example, the management server 20 may output a method for integrated management of the manufacturing site on a screen.

Next, the management server 20 may execute test questions for the manufacturing site management training visually or audibly (S410), receive results corresponding thereto, and generate mission performance data (S420).

Next, the management server 20 may analyze the mission performance data, and when the mission performance data is the same as standard mission performance data (S430), the management server 20 may generate training result data after the manufacturing site management training is completed (S440).

For example, when the mission performance data is the same as standard mission performance data, the management server 20 may end the manufacturing site management training.

Meanwhile, when the mission performance data is not the same as the standard mission performance data (S430), the management server 20 may generate and output a retraining message for re-executing the manufacturing site management training (S450).

That is, when the mission performance data is not included within a standard range, a worker or an administrator may undergo the manufacturing site management training again.

The operations of the method or algorithm described in conjunction with the embodiment of the present invention may be implemented directly in hardware, implemented as a software module executed by hardware, or implemented by a combination thereof. The software module may reside on a random access memory (RAM), a read only memory (ROM), an erasable programmable ROM (EPROM), an electrically erasable programmable ROM (EEPROM), a flash memory, a hard disk, a removable disk, a compact disc read only memory (CD-ROM), or any type of computer-readable recording medium well known in the art to which the invention pertains.

According to the present invention, it is possible to monitor a site of root industry in real time through big data analysis and efficiently manage and control the site.

According to the present invention, by estimating a production volume of a product and a lifetime of an apparatus using data for a manufacturing site to generate and manage control data for maximizing the production volume of the product and the lifetime of the apparatus, it is possible to prevent wasted time and reduced productivity.

Effects of the present invention are not limited to the above-described effects and other effects that are not described may be clearly understood by those skilled in the art from the above detailed descriptions.

While embodiments of the present invention have been described with reference to the accompanying drawings, it will be understood by those skilled in the art that various modifications can be made without departing from the scope of the present invention and without changing essential features. Therefore, the above-described embodiments should be considered in a descriptive sense only and not for purposes of limitation.

What is claimed is:

1. A manufacturing site integrated management method for root industry, which is performed by a server, comprising:
generating standard data by repeatedly learning big data based on root industry;
receiving manufacturing site data for a manufacturing site, analyzing the received manufacturing site data, and generating manufacturing analysis data; and
generating manufacturing management data using the manufacturing analysis data on the basis of the standard data,
wherein the generating of the manufacturing management data includes extracting energy usage and carbon emissions using the manufacturing analysis data to measure an actual production volume of a product and an actual lifetime of an apparatus and generate management measurement data, and
analyzing the management measurement data to estimate an estimated production volume of the product and an estimated lifetime of the apparatus for remaining lifetime excluding the actual lifetime on the basis of a total lifetime of the apparatus and generate management estimation data using data that matches the standard data.

2. The manufacturing site integrated management method of claim 1, wherein the generating of the manufacturing analysis data includes:
classifying the manufacturing site data by each field corresponding to at least one of casting, molding, welding, plastic processing, surface treatment, and heat treatment, classifying the manufacturing site data by each apparatus for manufacturing products manufactured by each field, classifying the manufacturing site data by each process corresponding to at least one of working time, non-working time, after-sales service (AS) time, and working speed for each apparatus, or classifying the manufacturing site data by each product corresponding to at least one of a casting product, a molding product, a welding product, a plastic processing product, a surface treatment product, and a heat treatment product; and
analyzing the manufacturing site data classified by each field, apparatus, process, or product on the basis of the standard data and generating the manufacturing analysis data.

3. The manufacturing site integrated management method of claim 2, comprising,
before the generating of the manufacturing analysis data,
converting the manufacturing site data into text;
preprocessing the manufacturing site data converted into the text; and
extracting a keyword from the preprocessed text,
wherein the preprocessing of the manufacturing site data includes performing a tokenization operation using a space removal filter and a special character removal filter so that words included in the manufacturing site data consisting of text are divided into minimum units of meaningful words,
after the tokenization operation has been completed, performing a refining operation to highlight the meaning of remaining words after removing noise data for words that appear less frequently or words that are repeated many times in the text, and
after the refining operation has been completed, normalizing the text and preprocessing the manufacturing site data.

4. The manufacturing site integrated management method of claim 2, wherein the classifying of the manufacturing site data further includes classifying the manufacturing site data by each biosignal corresponding to at least one of fatigue, movement, and working hours of a worker, and whether the worker commutes to work or classifying the manufacturing site data by each site environment corresponding to at least one of temperature, humidity, smoke, flames, harmful gas, fine dust concentration, oxygen concentration, noise, and vibrations,
wherein the generating of the manufacturing management data further includes generating management control data for controlling the manufacturing site to calculate a maximum production volume of the product and a maximum lifetime of the apparatus in response to the management estimation data.

5. The manufacturing site integrated management method of claim 2, wherein the generating of the manufacturing management data includes:
generating a simulation model using the management estimation data;
generating simulated manufacturing site data simulated by each field, apparatus, process, or product at the manufacturing site through the simulation model;
analyzing the simulated manufacturing site data and generating simulated manufacturing analysis data;
extracting the energy usage and the carbon emissions using the simulated manufacturing analysis data to simulate a maximum production volume of the product and a maximum lifetime of the apparatus and generate simulation result data; and
generating the manufacturing management data including the management estimation data reflecting the simulation result data.

6. A manufacturing site integrated management system for root industry, comprising:
a site control device that is placed at a manufacturing site and configured to generate manufacturing site data for the manufacturing site; and
a management server configured to generate manufacturing analysis data by comparing and analyzing the manufacturing site data, and generate manufacturing management data using the manufacturing analysis data on the basis of standard data,
wherein the management server extracts energy usage and carbon emissions using the manufacturing analysis data and measures a production volume of a product and a lifetime of an apparatus to generate management measurement data, and analyzes the management measurement data and estimates an estimated production volume of the product and an estimated lifetime of the apparatus for remaining lifetime excluding the actual lifetime on the basis of a total lifetime of the apparatus to generate management estimation data using data that matches the standard data.
